(19) United States
(12) Patent Application Publication
(10) Pub. No.: US 2013/0054597 A1
(43) Pub. Date: Feb. 28, 2013

(54) CONSTRUCTING AN ASSOCIATION DATA STRUCTURE TO VISUALIZE ASSOCIATION AMONG CO-OCCURRING TERMS

(71) Applicants: Ming C. Hao, Palo Alto, CA (US); Umeshwar Dayal, Saratoga, CA (US); Christian Rohrdantz, Konstanz (DE); Lars-Erik Haug, Gilroy, CA (US)

(72) Inventors: Ming C. Hao, Palo Alto, CA (US); Umeshwar Dayal, Saratoga, CA (US); Christian Rohrdantz, Konstanz (DE); Lars-Erik Haug, Gilroy, CA (US)

(21) Appl. No.: 13/215,322

(22) Filed: Aug. 23, 2011

(51) Int. Cl. G06F 17/30

(52) U.S. Cl. 707/737; 707/E17.045

(57) ABSTRACT

Extended associations are determined based on binary associations. The extended associations are associations among three or more terms in input data, and the binary associations are between terms in the input data. An association data structure having a plurality of entries is constructed, where at least a particular one of the plurality of entries includes visual elements representing terms that are associated according to the binary associations and the extended associations, and where the association data structure provides a visualization of an association pattern among co-occurring terms in the input data

### BACKGROUND

Users often provide feedback, in the form of reviews, regarding offerings (products or services) of different enterprises. As examples, users can be external customers of an enterprise, or users can be internal users within the enterprise. An enterprise may wish to use feedback to improve their offerings. However, there can be potentially a very large number of received reviews, which can make meaningful analysis of such reviews difficult and time-consuming.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments are described with respect to the following figures:

FIGS. 1A-1B are a flow diagrams of processes of providing visual analytics according to various implementations;

FIGS. 2-3 illustrate association data structures for visualizing associations among co-occurring terms in input data, in accordance with various implementations; and

FIG. 4 is a block diagram of an example system incorporating some implementations.

### DETAILED DESCRIPTION

An enterprise (e.g. a company, educational organization, government agency, an internal department within any of the foregoing entities, etc.) may collect feedback from users (which can either be external users or internal users) to better understand user sentiment regarding an offering of the enterprise. Feedback can be received in the form of reviews. An offering can include a product or a service provided by the enterprise (either to an external user or to an internal user). A “sentiment” refers to an attitude, opinion, or judgment of a human with respect to the offering.

An enterprise can provide an online website to collect feedback from users. Alternatively or additionally, the enterprise can also collect feedback through telephone calls or through paper survey forms. Furthermore, feedback can be collected at third party sites, such as travel review websites, product review websites, and so forth. Some third party websites provide professional reviews of offerings from enterprises, as well as provide mechanisms for users to submit their individual reviews.

Additionally, if the users are internal users of enterprise, various mechanisms can also be provided within the enterprise for internal users to submit feedback. If there are a relatively large number of users, then there can be relatively large amounts of user feedback.

Generally, sentiment analysis involves identifying each term appearing in the reviews (which can be in the form of unstructured data) and assigning some score to the term, which can be a negative score, neutral score, or positive score to express whether the term is associated with negative sentiment, neutral sentiment, or positive sentiment. Determining the score can be based on opinion words appearing in portions (e.g. sentences, paragraphs, other sections) that are near a corresponding term. “Unstructured data” refers to data that does not have a predefined format or schema (such as a schema of a relational database management system).

A “term” refers to a word or a combination of words for which a sentiment can be expressed. As examples, a term can be a noun or compound noun (a noun formed of multiple words, such as “customer service”) that exists in the feedback information. As other examples, a term can be any other word or combination of words that an analyst wishes to consider, where the word(s) can be an attribute (noun or compound noun), an adjective, a verb, and so forth. Sentiment words (or opinion words) in the feedback information can also be identified, where sentiment words include individual words or phrases (made up of multiple words) that express an attitude, opinion, or judgment of a human. Examples of sentiment words include “bad,” “poor,” “great performance,” “fast service,” and so forth.

Sentiment scores can be assigned to respective terms based on use of any of various different sentiment analysis techniques, which involve identifying words or phrases in the data records that relate to sentiment expressed by users with respect to each attribute. A sentiment score can be generated based on the identified words or phrases. The sentiment score provides an indication of whether the expressed sentiment is positive, negative, or neutral. The sentiment score can be a numeric score, or alternatively, the sentiment score can have one of several discrete values (e.g. Positive, Negative, Neutral).

Although assigning sentiment scores to terms that may appear in reviews may be useful for various purposes, it is noted that identifying individual terms by themselves may not adequately allow for identification of patterns of terms that may be present in the reviews. Patterns of terms may be based on co-occurrence of the terms within the reviews, which can be co-occurrence of the terms in sentences within the reviews, paragraphs within the reviews, other sections of the reviews, or the entirety of the reviews. For example, in the context of reviews of a given hotel, the hotel owner may wish to find which term is most closely related to the term “hotel room.” Example terms that can be related to “hotel room” can include “bathroom,” “carpet,” and so forth.

In accordance with some implementations, an association data structure (which can be in the form of an association matrix or other type of data structure) can be provided to visualize association among co-occurring terms in input data (which can include reviews in the form of documents or other objects). An association between or among two or more terms refers to co-occurrence of the two or more terms in a review or some portion of the review (e.g. sentence, paragraph, or other section). The visualized association data structure shows association patterns of the co-occurring terms that may be of interest to users. In some implementations, the visualized association data structure allows for visualization of the association patterns in a single display even if there are a large number of co-occurring terms. In accordance with some implementations, terms are visualized only as part of the association data structure. In this association data structure, visual elements representing the terms are assigned respective colors (or other visual indicators) to indicate corresponding sentiments as expressed in sentences (or other portions of a review) with respect to the terms.

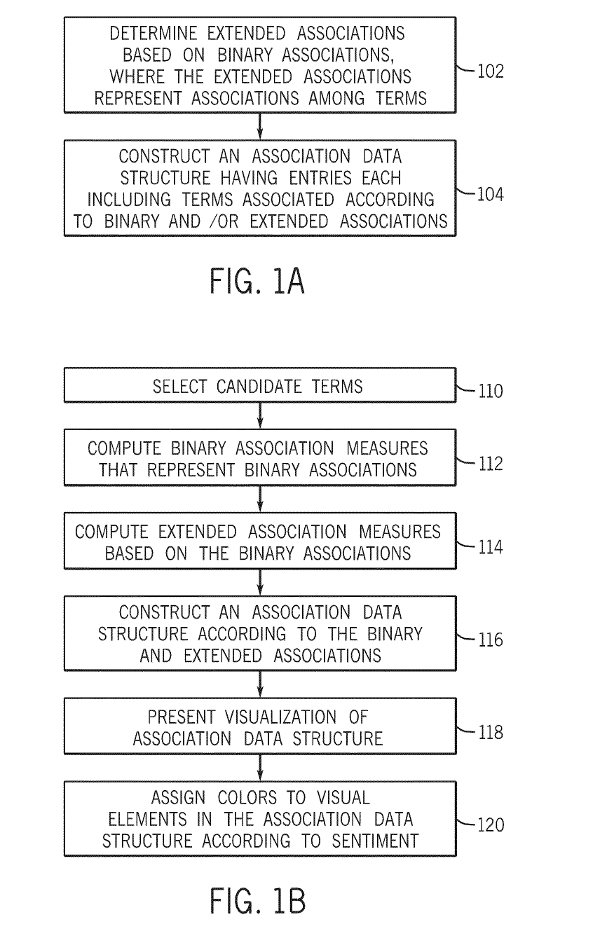

FIG. 1A is a flow diagram of a process according to some implementations. The process of FIG. 1 determines (at 102) extended associations among co-occurring terms in reviews based on binary association measures. An association measure provides a metric regarding association between or among multiple terms. A binary association represents a pair-wise association between two terms. An extended association represents association among three or more terms. A binary association measure provides an indication of a degree of association between a pair of terms, while an extended association measure provides an indication of a degree of association among three or more terms.

Binary association measures can be computed using any one of various different techniques. As examples, such techniques include a hypothesis testing technique (in which a tester starts with a null hypothesis and an alternative hypothesis performs an experiment, and then decides whether to reject the null hypothesis in favor of the alternative hypothesis—the hypothesis testing is basically a binary classification of the hypothesis under study); a likelihood statistics technique, such as a likelihood ratio test technique (which is a statistical test used to compare the fit of two models, one of which (the null model) is a special case of the other, the alternative model), where the test is based on a likelihood ratio that expresses how many times more likely the data is under one model than the other); a phi correlation technique (which is a technique for correlating the association between two variables); an information theory technique, such as a mutual information technique (which is a technique to determine a quantity, referred to as the mutual information, that measures the mutual dependence of two variables), or some other association or correlation technique for correlating pairs of variables (which in some implementations include terms found in feedback reviews).

The process of FIG. 1 constructs (at 104) an association data structure having multiple entries. In some implementations, the association data structure is an association matrix that has an array of entries, where each entry in the array includes terms that are associated with each other according to binary associations and/or extended associations. The association data structure provides a visualization of association among co-occurring terms that are found in feedback from users.

Extended associations are derived based on binary associations. Stated differently, binary associations can be extended beyond binary relations to depict relations among more than two terms. In some examples, binary associations can be merged to form extended associations. In the following example, the following binary associations can be merged: (a, b), (a, c), (b, c), where a, b, c represent terms that can be found in reviews, and each of (a, b), (a, c), (b, c) represents a corresponding binary association between the respective pair of terms in parentheticals. The foregoing binary associations are a subset of a collection (A) of binary associations, which can be a collection of hypothesis test associations, a collection of likelihood ratio associations, a collection of phi associations, or a collection of mutual information associations, as examples.

In some examples, the binary associations (a, b), (a, c), and (b, c) can be merged if the following condition is satisfied:

(a,b)εA [symbol] (a,c)εA [symbol] (b,c)εA, (the “ [symbol] ” symbol represents logical AND)

I(a,b,c)>max(I(a,b),I(a,c),I(b,c)),

count(a,b,c)>lowerbound.

In the foregoing, I( ) represents a function for computing an association measure. For example, I( ) can represent a function for computing a pointwise mutual information, according to the following formula (in the binary case):

I(a,b)=p(a,b)/(p(a)*p(b)),

where p( ) represents a probability of the corresponding item—e.g. p(a) represents the probability of the term a occurring in received feedback, and p(a,b) represents the probability of both terms a and b occurring in received feedback.

Thus, I(a,b) represents an example score (pointwise mutual information) indicating the binary association between terms a and b. In the more general sense, when correlating more than two terms, the following extended association measure can be used:

I(a,b, . . . ,n)=p(a,b, . . . ,n)/(p(a)*p(b)* . . . *p(n)),

where I(a, b, . . . , n) represents an example measure of an extended association among terms a, b, . . . , n. In other words, the extended association measure for the extended association of terms a, b, c is represented by I(a, b, c) in the foregoing example.

Also, count(a) represents the count of the number of sentences that contain term a, and lowerbound represents a predefined threshold. In the condition above, count(a, b, c) represents the count of the number of sentences (or reviews or other sections of reviews) that contain all of the terms a, b, c.

The specific condition set forth above for merging the foregoing binary associations is true if each of the binary associations is a member of A, the extended association measure I(a, b, c) is greater than the maximum of the following binary association measures I(a, b), I(a, c), and I(b, c), and the count(a, b, c) is greater than the lower bound predefined threshold, lowerbound. Although a specific condition for merging binary associations is provided above, it is noted that in alternative examples, other conditions can be specified for merging binary associations to form extended associations, where such condition for merging is based on binary association measures.

FIG. 1B is a flow diagram of a process according to alternative implementations. The process of FIG. 1B selects (at 110) terms from a set of candidate terms, with the selection based on human domain knowledge regarding what terms may be of interest, for example. Using a collection of the selected terms, binary association measures are computed (at 112) that represent binary associations between pairs of the selected terms. Next, extended association measures are computed (at 114) based on the binary associations (and the respective binary association measures), such as according to examples as discussed above. Each extended association measure represents a respective extended association among three or more of the selected terms.

The process then constructs (at 116) an association data structure according to the binary and extended associations, similar to task 104 in FIG. 1A. Next, the process presents (at 118) a visualization of the association data structure. The process assigns (at 120) colors to visual elements in the association data structure, according to sentiment based on user feedback in received reviews. Each visual element in the association data structure can represent a respective term, and the color assigned to the visual element represents a respective sentiment (e.g. positive sentiment, negative sentiment, or neutral sentiment). In other implementations, instead of assigning colors to visual elements to represent respective sentiments, other types of visual indicators can be used, such as cross-hatching, different gray levels, and so forth.

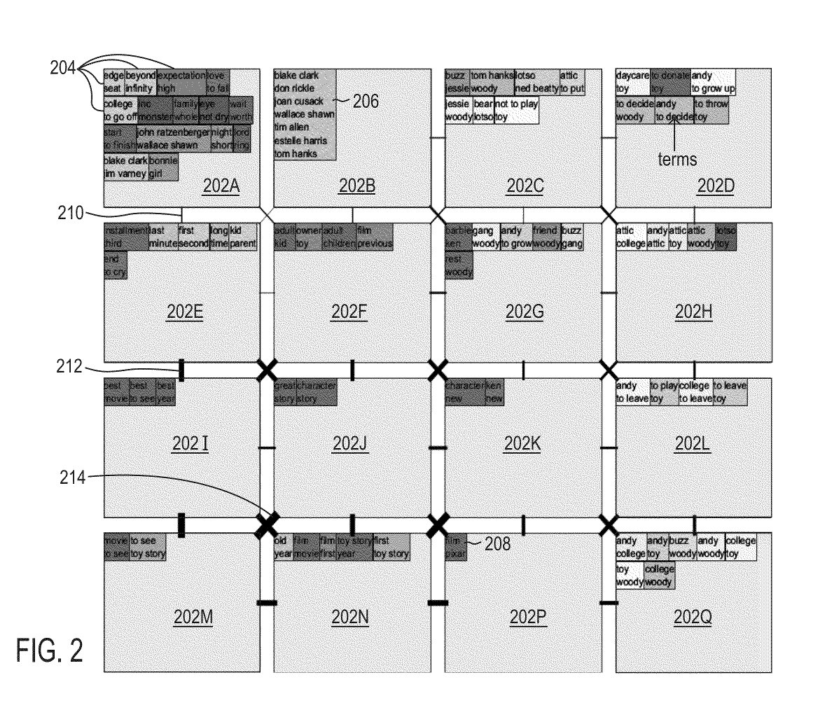

FIG. 2 shows an example association matrix, which is a type of association data structure discussed above. The association matrix is a 4×4 array of entries 202 (202A-202Q depicted in FIG. 2). Each entry 202, represented by a respective box in FIG. 2, contains co-occurring terms, represented by respective visual elements. For example, in entry 202A, visual elements 204 represent respective terms, including “edge seat,” “beyond infinity,” “expectation high,” etc.

Each visual element is associated with a respective color (or alternatively, another type of visual indicator), which can be used to indicate the corresponding sentiment expressed with respect to the term, where the sentiment can be a positive sentiment, a neutral sentiment, or a negative sentiment. In some examples, a green color (light green or darker green) can indicate a positive sentiment, where the darker shade of green represents a more positive sentiment than a lighter shade of green. A gray color assigned to a visual element indicates a neutral sentiment associated with the corresponding term, while a red color (lighter shade of red or darker shade or red) represents a negative sentiment expressed with respect to the respective term. A darker shade of red represents a more negative sentiment than a lighter shade of red.

Entries 202B and 202P each contains only one visual element (206 in entry 202B and 208 in entry 202P)—this indicates that no co-occurring terms are associated with entries 202B and 202P.

In FIG. 2, the text of the terms associated with respective visual elements in each of the entries is visible. In alternative examples, if there are a larger number of entries in an association matrix, the visual elements may be small enough such that the terms associated with the visual elements may not be visible—in such examples, a user can move a cursor over a particular visual element to view a pop-up box that contains the corresponding term.

Each entry 202 of the association matrix shown in FIG. 2 contains terms relating to binary or extended associations that tend to be contained in similar reviews. In some examples, the association matrix of FIG. 2 is a self-organizing map (SOM) that has an n×n topology (4×4 topology in examples according to FIG. 2). Each entry of the n×n matrix corresponds to an SOM-node, where an SOM-node represents a cluster of data objects, in this case binary or n-ary (where n is greater than or equal to 3) associations. Those associations that are clustered into a corresponding SOM-node (corresponding entry 202 of the association matrix) are those associations that tend to be contained by similar documents (that represent respective reviews). For example, if greater than some predefined threshold number of documents contain both the association (a, b, c) and the association (g, m), then the terms in both these associations will likely end up in the same SOM-node (entry 202).

FIG. 2 also shows lines interconnecting respective pairs of the entries 202. Each line interconnecting a pair of entries 202 has a thickness that represents how similar the two entries are within a similarity space. For example, line 210 has a thickness that is less than the thickness of line 212, which indicates that entries 202A and 202E are less similar to each other than entries 202E and 202I are to each other. Similarly, the line 212 has a thickness that is less than the thickness of a line 214, which indicates that entries 202J and 202M (interconnected by the line 214) are more similar to each other than entries 202E and 202I (interconnected by the line 212) are to each other.

In some examples, each association (binary association or extended association) is represented by a high-dimensional numerical vector (“association vector”) that contains one dimension for each review in the corpus. This association vector can have a relatively large number of bit positions, where each bit position corresponds to a respective review. If a review contains the respective association (binary association or extended association), then the association vector corresponding to the association has an entry “1” at the respective bit position, and “0” otherwise. Although “1” and “0” are used, it is noted that in alternative implementations, different values can be used to indicate whether the corresponding review contains the respective association.

Each entry 202 in FIG. 2 contains one or multiple associations. The entry 202 is represented by a centroid vector of all the association vectors contained in the entry 202. The centroid vector is based on aggregating (e.g. averaging, taking the mean of, or other aggregate computation of) the association vectors in the entry 202. The inverse of the distance between two entries (as represented by respective centroid vectors) is mapped to the thickness of the lines. The smaller the distance between two centroids (indicating higher similarity), the thicker the line (indicating stronger connection). The distance may be calculated as a Euclidian distance between centroid vectors. In other implementations, other techniques for determining similarity between entries can be used, where such similarity is represented by the lines interconnecting the entries.

In other implementations, instead of using lines to interconnect the entries 202 of the association data structure, other interconnecting elements can be used, with each interconnecting element connecting at least two entries of the association data structure, and with each interconnecting element having an indicator to indicate a degree of association between or among the entries.

In some examples, various visual analytic techniques can be applied to the visualized association data structure. For example, a user can move a cursor (with a mouse or other input device) over a portion of the visualized association data structure (e.g. over a visual element corresponding to a term), and view further details regarding the term and its association(s) with other terms. Moreover, a user can select a portion of the visualized association data structure (such as by drawing a box around the selected portion using a rubber-banding operation, for example) to zoom (drill down) into the selected portion. As further examples, a user can click on the visual element of a term of interest to quickly find association(s) of this term.

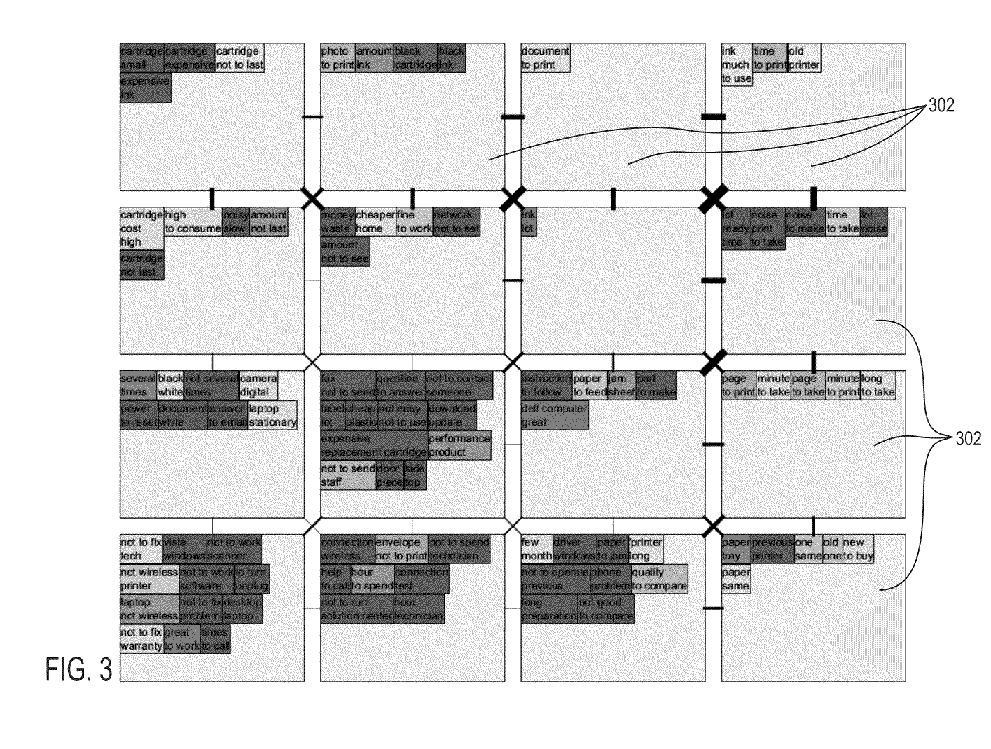

FIG. 3 illustrates a different example association matrix that also includes a 4×4 array of entries 302. Visual indicators are provided in each entry 302 that corresponds to respective terms that appear in respective binary or extended associations. As compared to the example association matrix of FIG. 2, there are a larger number of red-colored visual elements in the FIG. 3 association matrix, to indicate greater negative sentiment expressed in terms represented by the FIG. 3 association matrix, as compared to the terms represented by the FIG. 2 association matrix.

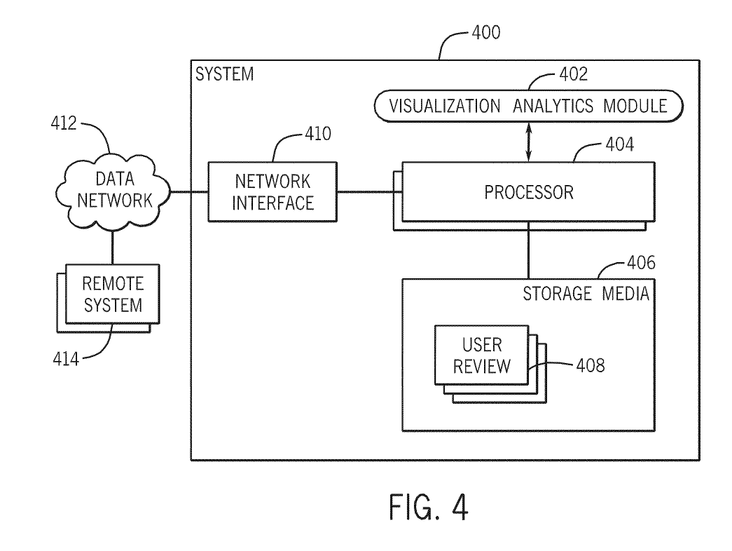

FIG. 4 is a block diagram of an example system 400 that includes a visualization analytics module 402 executable on one or multiple processors 404. A processor can include a microprocessor, microcontroller, processor module or subsystem, programmable integrated circuit, programmable gate array, or another control or computing device. The visualization analytics module 402 can perform the various tasks discussed above, including any of the processes of FIGS. 1A and 1B. The processor(s) 404 is (are) connected to storage media 406, which can store user reviews 408. In addition, the system 400 includes a network interface 410, which allows the system 400 to communicate over a data network 412 with remote system(s) 414. Further user reviews can be received from the remote system(s) 414 at the system 400, which can be further processed by the visualization analytics module 402 according to some implementations.

The storage media 406 can be implemented as one or multiple computer-readable or machine-readable storage media. The storage media can include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method of a system having a processor, comprising:
determining extended associations based on binary association measures, wherein the extended associations are associations among three or more terms in input data, and the binary association measures represent pair-wise associations between terms in the input data; and
constructing an association data structure having a plurality of entries, wherein at least a particular one of the plurality of entries includes visual elements representing terms that are associated according to the pair-wise associations and the extended associations, and wherein the association data structure provides a visualization of an association pattern among co-occurring terms in the input data.

2. The method of claim 1, further comprising assigning colors to the visual elements in the particular entry to indicate corresponding sentiments regarding the corresponding terms, wherein the sentiments are based on opinion words appearing in portions of reviews in the input data.

3. The method of claim 2, wherein assigning the colors comprises assigning different colors to indicate a positive sentiment, a negative sentiment, and a neutral sentiment, respectively.

4. The method of claim 1, further comprising:
providing interconnecting elements between respective pairs of the entries of the association data structure, wherein the interconnecting elements are associated with indicators to indicate degrees of association between respective pairs of the entries.

5. The method of claim 4, further comprising:
determining the indicators of the interconnecting elements based on vectors associated with the corresponding pair-wise associations and the extended associations.

6. The method of claim 5, further comprising:
for each of the entries of the association data structure, defining a centroid of the vectors corresponding to the associations of the respective entry; and
computing distances between respective pairs of centroids to derive the indicators.

7. The method of claim 4, wherein the interconnecting elements include lines interconnecting the entries, and the indicators comprise different widths of the lines.

8. The method of claim 1, wherein constructing the association data structure comprises constructing an association matrix having an array of the entries.

9. The method of claim 1, further comprising:
receiving user selection of a given one of the terms represented by the association data structure; and
identifying terms associated with the given term in response to the user selection.

10. An article comprising at least one machine-readable storage medium storing instructions that upon execution cause a system to:
identify binary associations between respective pairs of terms in input data;
determine extended associations based on the binary associations, wherein the extended associations are associations among three or more terms in the input data; and
construct an association data structure having a plurality of entries, wherein at least a particular one of the plurality of entries includes terms that are associated according to the binary associations and the extended associations, and wherein the association data structure provides a visualization of an association pattern among co-occurring terms in the input data.

11. The article of claim 10, wherein the instructions upon execution cause the system to further:
present a visualization of the association data structure.

12. The article of claim 11, wherein the visualization of the association data structures includes visual elements representing respective terms, and wherein the instructions upon execution cause the system to further assign different visual indications to the respective visual elements to represent respective sentiments associated with the corresponding terms, wherein the sentiments are based on sentiment words in the input data.

13. The article of claim 12, wherein assigning the different visual indicators comprises assigning different colors.

14. The article of claim 10, wherein the input data includes reviews, wherein each of the binary associations is an association between a pair of terms in a respective review or portion of a review, and wherein each of the extended associations is an association between three or more terms in a respective review or portion of a review.

15. The article of claim 10, wherein determining a particular one of the extended associations comprises combining at least two of the binary associations in response to a condition being satisfied.

16. The article of claim 15, wherein the condition is based on binary association measures associated with the at least two binary associations.

17. The article of claim 10, wherein the instructions upon execution cause the system to further:
provide interconnecting elements between respective pairs of the entries of the association data structure, wherein the interconnecting elements are associated with indicators to indicate degrees of association between respective pairs of the entries.

18. The article of claim 17, wherein the interconnecting elements are lines, and the indicators include different widths of the lines.

19. A system comprising:
a storage medium to store reviews; and
at least one processor to:
determine extended associations based on binary association measures, wherein the extended associations are associations among three or more terms in the reviews, and the binary association measures represent pair-wise associations between terms in the reviews; and
construct an association data structure having a plurality of entries, wherein at least a particular one of the plurality of entries includes visual elements representing terms that are associated according to the pair-wise associations and the extended associations, and wherein the association data structure provides a visualization of an association pattern among co-occurring terms in the reviews.

20. The system of claim 19, wherein the visual elements are assigned different colors to indicate different sentiments associated with respective terms.
